(19) United States
(12) Patent Application Publication
(10) Pub. No.: US 2009/0237406 A1
(43) Pub. Date: Sep. 24, 2009

(54) CHARACTER RENDERING SYSTEM

(76) Inventors: Chun-Chia Chen, Hsinchu City (TW); Chi-Cheng Ju, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/052,736

(22) Filed: Mar. 21, 2008

(51) Int. Cl. G06T 11/00

(52) U.S. Cl. 345/441

(57) ABSTRACT

To facilitate a low-power/power-aware, high-speed, and high-quality/quality-adaptive character rendering process, a character rendering system including a memory, a cache unit, a Bezier curve parallel decomposition module, a transfer controller, a parallel anti-aliasing module, a buffer, and a scan conversion unit is disclosed. The cache unit stores a plurality of Bezier curve key points corresponding to frequently used characters. The Bezier curve parallel decomposition module performs parallel decomposing processes on the Bezier curves of the Bezier curve key points corresponding to a character for generating a plurality of segments. The parallel anti-aliasing module performs parallel anti-aliasing processes on data of the segments transferred by the transfer controller for generating edge pixel data. The edge pixel data are transferred to the scan conversion unit via the memory or the buffer. The scan conversion unit performs a scan conversion process on the edge pixel data for generating image data of the character.

### BACKGROUND OF THE INVENTION

1. Field of the Invention

The present invention relates to a character rendering system, and more particularly, to a low-power/power-aware, high-speed, and high-quality/quality-adaptive character rendering system.

2. Description of the Prior Art

Electronic devices have been developed over years, and handheld information appliances (IAs), such as mobile phones, set-top boxes, personal digital assistants (PDAs), MP3 media players, and MP4 media players, are more popular than ever. Almost every IA device has a display screen so as to show related information for user operation. Normally, these small-size IA devices demonstrate small-size characters on display screens compared to desktop display screens with limited power and small memory size. Furthermore, to improve display quality, the use of outline fonts becomes increasingly popular than that of bitmap fonts due to the scaling flexibility. However, compared to bitmap fonts, outline fonts need supplicated rendering technology and a large amount of computations. Accordingly, character rendering systems for outline fonts and achieving low-power/power-aware, low-memory-size, high-speed, and high-quality/quality-adaptive system features have been extensively developed uninterruptedly.

### SUMMARY OF THE INVENTION

In accordance with an embodiment of the present invention, a character rendering system for meeting the demand of the forthcoming IA devices is provided. The character rendering system for rendering a character comprises a memory, a cache unit, a Bezier curve decomposition unit, an anti-aliasing unit, and a scan conversion unit. The memory is utilized for storing a plurality of Bezier curve key points and edge pixel data of the character. The cache unit is coupled to the memory for storing parts of the Bezier curve key points. The Bezier curve decomposition unit is coupled to the cache unit for generating a plurality of segments corresponding to the character by decomposing a plurality of Bezier curves based on Bezier curve key points corresponding to the character, wherein the Bezier curve decomposition unit fetches the Bezier curve key points corresponding to the character from the cache unit. The anti-aliasing unit is coupled between the Bezier curve decomposition unit and the memory for generating the edge pixel data of the character by performing an anti-aliasing process on the segments corresponding to the character. The scan conversion unit is coupled to the memory for generating image data of the character by performing a scan conversion process on the edge pixel data of the character.

The present invention further provides a character rendering system for rendering a character comprising a memory, a Bezier curve decomposition unit, an anti-aliasing unit, an encoder, a decoder, and a scan conversion unit. The memory stores a plurality of Bezier curve key points and edge pixel data of the character. The Bezier curve decomposition unit is coupled to the memory for generating a plurality of segments corresponding to the character by decomposing a plurality of Bezier curves based on Bezier curve key points corresponding to the character. The anti-aliasing unit is coupled to the Bezier curve decomposition unit for generating the edge pixel data of the character by performing an anti-aliasing process on data of the segments corresponding to the character. The encoder is coupled between the anti-aliasing unit and the memory for generating encoded edge pixel data of the character by encoding the edge pixel data of the character. The decoder is coupled to the memory for recovering the edge pixel data of the character by decoding the encoded edge pixel data of the character. The scan conversion unit is coupled to the decoder for generating image data of the character by performing a scan conversion process on the edge pixel data of the character.

The present invention further provides another character rendering system for rendering a character comprising a memory, a Bezier curve parallel decomposition module, a transfer controller, a parallel anti-aliasing module, and a scan conversion unit. The memory is utilized for storing a plurality of Bezier curve key points and edge pixel data of the character. The Bezier curve parallel decomposition module is coupled to the memory for generating a plurality of segments corresponding to the character by decomposing a plurality of Bezier curves based on Bezier curve key points corresponding to the character. The Bezier curve parallel decomposition module comprises a plurality of Bezier curve decomposition units. Each of the Bezier curve decomposition units decomposes one of the Bezier curves corresponding to the character based on corresponding Bezier curve key points for generating parts of the segments corresponding to the character. The Bezier curve parallel decomposition module dispenses the received Bezier curve key points of the Bezier curves corresponding to the character to the Bezier curve decomposition units. The transfer controller comprises a plurality of input ports and output ports. The input ports are coupled to the Bezier curve decomposition units respectively for receiving data of the segments corresponding to the outline of the character. The transfer controller distributes the received data of the segments corresponding to the character to the output ports. The parallel anti-aliasing module is coupled between the transfer controller and the memory for generating the edge pixel data of the character by performing parallel anti-aliasing processes on the data of the segments corresponding to the character received from the output ports of the transfer controller. The parallel anti-aliasing module comprises a plurality of anti-aliasing units. The anti-aliasing units are coupled to the output ports of the transfer controller respectively. Each of the anti-aliasing units performs an anti-aliasing process on parts of the data of the segments corresponding to the character received from a corresponding output port for generating parts of the edge pixel data of the character. The scan conversion unit is coupled to the memory for generating image data of the character by performing a scan conversion process on the edge pixel data of the character.

Still, the present invention provides another character rendering system for rendering a character comprising a memory, a Bezier curve decomposition unit, an edge pixel computing module, and a scan conversion unit. The memory is utilized for storing a plurality of Bezier curve key points and edge pixel data of the character. The Bezier curve decomposition unit is coupled to the memory for generating a plurality of segments corresponding to the character by decomposing a plurality of Bezier curves based on Bezier curve key points corresponding to the character. The edge pixel computing module is coupled between the Bezier curve decomposition unit and the memory for generating the edge pixel data of the character from data of the segments corresponding to the character based on a power indication signal. The edge pixel computing module comprises a bi-level processing unit and a gray-level processing unit. The bi-level processing performs a bi-level edge judgment process on the data of the segments corresponding to the character for generating the edge pixel data of the character when the power indication signal indicates a low-power mode. The gray-level processing unit performs a gray-level anti-aliasing process on the data of the segments corresponding to the character for generating the edge pixel data of the character when the power indication signal indicates a high-power mode. The scan conversion unit is coupled to the memory for generating image data of the character by performing a scan conversion process on the edge pixel data of the character.

Further, the present invention provides another character rendering system for rendering a character comprising a memory, a Bezier curve decomposition unit, an edge pixel computing module, and a scan conversion unit. The memory is utilized for storing a plurality of Bezier curve key points and edge pixel data of the character. The Bezier curve decomposition unit is coupled to the memory for generating a plurality of segments corresponding to the outline of the character by decomposing a plurality of Bezier curves based on Bezier curve key points corresponding to the character. The edge pixel computing module is coupled between the Bezier curve decomposition unit and the memory for generating the edge pixel data of the character from data of the segments corresponding to the character based on a pixel division array dimension. The edge pixel computing module comprises an array dimension adjuster for adjusting the pixel division array dimension according to a power indication signal. The edge pixel computing module divides each edge pixel of the character into a plurality of sub-pixels and generates the edge pixel data of the character according to the pixel division array dimension. The scan conversion unit is coupled to the memory for generating image data of the character by performing a scan conversion process on the edge pixel data of the character.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a bock diagram showing a character rendering system in accordance with a first embodiment of the invention.

FIG. 2(a) is a schematic diagram illustrating an adaptive Bezier curve decomposition process in a low-power and low-quality mode according to the invention.

FIG. 2(b) is a schematic diagram illustrating an adaptive Bezier curve decomposition process in a high-power and high-quality mode according to the invention.

FIG. 3(a) is a schematic diagram illustrating a bank splitting process according to the invention.

FIG. 3(b) is a schematic diagram illustrating another bank splitting process according to the invention.

FIG. 4 is a bock diagram of a character rendering system in accordance with a second embodiment of the invention.

FIG. 5 is a bock diagram of a character rendering system in accordance with a third embodiment of the invention.

FIG. 6 is a bock diagram of a character rendering system in accordance with a fourth embodiment of the invention.

FIG. 7 is a schematic diagram showing the operation of the array dimension adjuster according to the present invention.

### DETAILED DESCRIPTION

Hereinafter, preferred embodiments of the present invention will be described in detail with reference to the accompanying drawings. Here, it is to be noted that the present invention is not limited thereto.

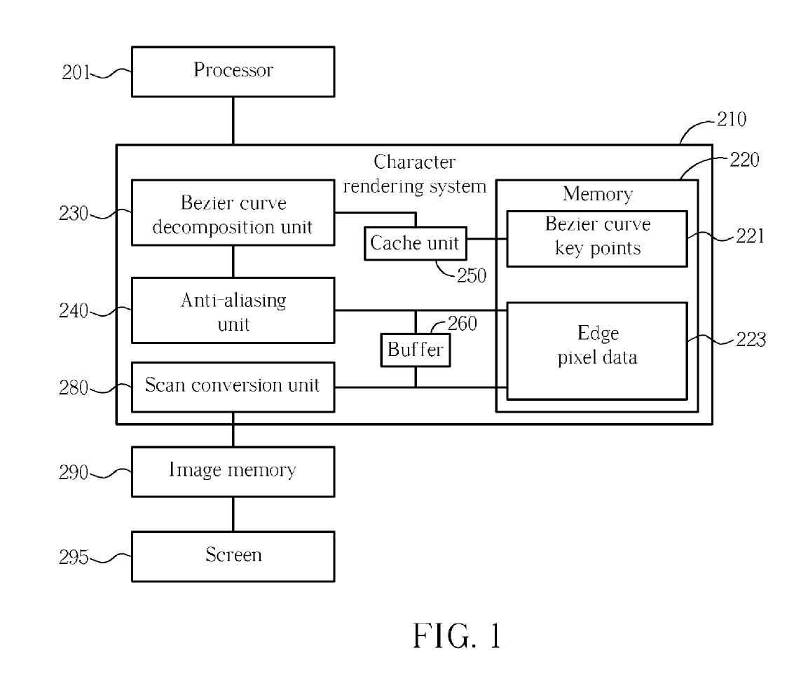

FIG. 1 shows a character rendering system 210 in accordance with a first embodiment of the present invention. The character rendering system 210 comprises a memory 220, a cache unit 250, a Bezier curve decomposition unit 230, an anti-aliasing unit 240, a buffer 260, and a scan conversion unit 280. The character rendering system 210 can be coupled to a processor 201 for receiving character display data such as font sizes. Besides, the character rendering system 210 may receive a power indication signal functioned as a control parameter for controlling system operation. The character rendering system 210 can also be coupled to an image memory 290 for providing image data of characters to be displayed on a screen 295 via the image memory 290.

The memory 220 stores a plurality of Bezier curve key points 221 and edge pixel data 223. The Bezier curve key points 221 are used for generating Bezier curves corresponding to character outlines, and the edge pixel data 223 are used for performing scan conversion processes. The memory 220 can be a dynamic random access memory (DRAM). The Bezier curve key points 221 comprise Bezier curve startpoints, endpoints and Bezier curve control points.

The cache unit 250 coupled between the memory 220 and Bezier curve decomposition unit 230, stores parts of the Bezier curve key points fetched from the memory 220. The cache unit 250 can be a static random access memory (SRAM). The parts of the Bezier curve key points stored in the cache unit 250 may be corresponding to a plurality of frequently used characters so that the character rendering process for the frequently used characters can be accelerated. Moreover, the data amount stored in the cache is much smaller than bit-map cache storing characters in bit-maps forms, since the cache unit 250 only stores the key points of the Bezier curves which is smaller than characters in bit-maps forms.

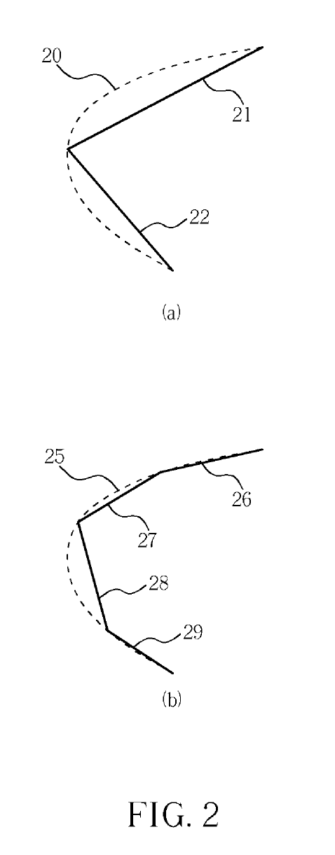

The Bezier curve decomposition unit 230 decomposes a plurality of Bezier curves corresponding to a character based on corresponding Bezier curve key points for generating a plurality of segments corresponding to the outline of the character. The number of segments decomposed from a Bezier curve by the Bezier curve decomposition unit 230 can be adjusted based on the power indication signal. That is, the Bezier curve decomposition unit 230 performs an adaptive decomposition process on the Bezier curves for generating the segments in a corresponding quality level according to the power indication signal. FIGS. 2(a) and (b) show two adaptive Bezier curve decomposition processes according to the present invention. FIG. 2(a) illustrates the adaptive Bezier curve decomposition process performed on a Bezier curve 20 for generating two segments 21 and 22 in a low-power and low-quality mode. FIG. 2(b) illustrates the adaptive Bezier curve decomposition process performed on a Bezier curve 25 for generating four segments 26-29 in a high-power and high-quality mode. The Bezier curve 20 is substantially identical to the Bezier curve 25. It is obvious that more segments are decomposed for the same Bezier curve in the high-power and high-quality mode compared to the low-power and low-quality mode.

In one preferred embodiment, the number of segments decomposed from a Bezier curve is adjusted to be smaller and greater respectively for power-saving rendering operation and high-quality rendering operation when the power indication signal indicates a low-power mode and a high-power mode. The Bezier curve key points used by the Bezier curve decomposition unit 230 are fetched from the cache unit 250 when the character to be displayed is one of the frequently used characters. Conversely, the Bezier curve key points are fetched from the memory 21 for the Bezier curve decomposition unit 230 when the character to be displayed is not within the collection of the frequently used characters. It is noted that the key points storing in the cache unit 250 may be updated to newly frequently used characters, but not fixed to a pre-defined character set.

The anti-aliasing unit 240, coupled to the Bezier curve decomposition unit 230, performs an anti-aliasing process on the segments corresponding to the character for generating corresponding edge pixel data of the character. The scan conversion unit 280, coupled to the memory 220 and buffer 260, performs scan conversion processes on the edge pixel data of the character for generating the image data of the character to be displayed on the screen 295. The buffer 260, coupled between the anti-aliasing unit 240 and scan conversion unit 280, can be a SRAM. The buffer 260 provides an auxiliary means for transferring the edge pixel data of the character from the anti-aliasing unit 240 to the scan conversion unit 280. That is, the edge pixel data of the character are transferred from the anti-aliasing unit 240 to the scan conversion unit 280 via the memory 220 or the buffer 260.

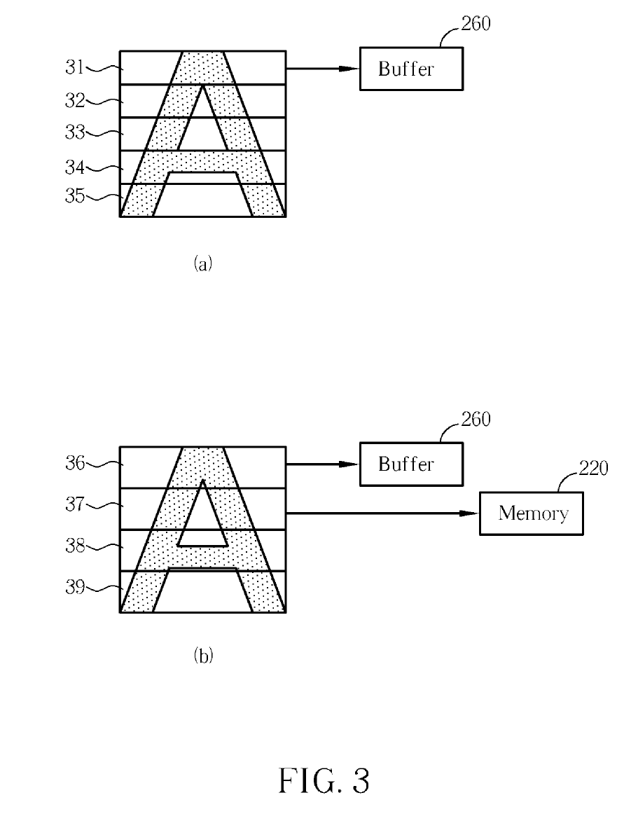

When the buffer 260 is capable of accommodating the edge pixel data of the character, the edge pixel data of the character are transferred from the anti-aliasing unit 240 to the scan conversion unit 280 via the buffer 260 so as to accelerate character rendering process and save power consumption by reducing data accessing concerning the memory 220. Furthermore, the edge pixel data of the character may comprise a plurality of edge pixel data banks. Please refer to FIGS. 3(a) and (b), which are schematic diagrams showing two bank splitting processes according to the present invention.

FIG. 3(a) illustrates the bank splitting process performed on a character “A” for generating five edge pixel data banks sequentially forwarded to the buffer 260. The character “A” having dotted region is divided into five banks 31-35, and the anti-aliasing unit 240 performs an anti-aliasing process on each of the five banks 31-35 for generating one corresponding edge pixel data bank forwarded to the buffer 260, wherein each edge pixel data bank corresponds to the outline of respective bank. That is, all the five edge pixel data banks are sequentially transferred from the anti-aliasing unit 240 to the scan conversion unit 280 via the buffer 260. The scan conversion unit 280 accordingly performs scan conversion processes thereon upon receiving each edge pixel data bank. With only storing edge pixel data corresponding one or some of the data banks of character being rendered, the buffer 260 can be utilized effectively, thereby reducing size of the memory 220 and bandwidth and times of accessing the memory 220 significantly for having lower power consumption. FIG. 3(b) illustrates another bank splitting process with dividing character “A” into four banks 36-39. Similarly, the anti-aliasing unit 240 performs an anti-aliasing process on each of the four banks 36-39 for generating one corresponding edge pixel data bank which is sequentially transferred to the scan conversion unit 280 via the buffer 260 or the memory 220 according to the size of the edge pixel data bank. Accordingly, with dividing the edge pixel data of the character into a plurality of edge pixel data banks, the edge pixel data banks or a part thereof can be stored in the buffer 260 for the scan conversion unit 280 instead of the memory 220, reducing the memory bandwidth. It is noted that the number of the data banks of the character can be adjusted according to design necessity, such as the size of the buffer 260.

In summary, the character rendering system 210 is capable of rendering high-quality characters at a higher speed with lower power consumption compared to the prior-art character rendering system 110. In addition, the character rendering system 210 is capable of operating a quality-adaptive character rendering process based on an adaptive Bezier curve decomposing process so that high-quality characters are displayed in a high-power mode and low-quality characters are displayed in a low-power mode.

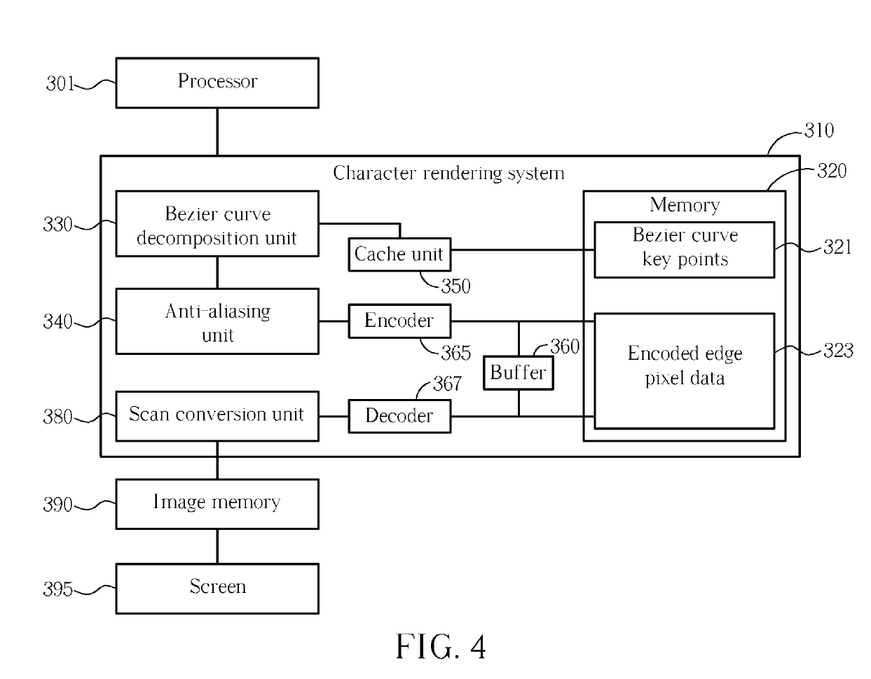

FIG. 4 shows a character rendering system 310 in accordance with a second embodiment of the present invention. The character rendering system 310 comprises a memory 320, a cache unit 350, a Bezier curve decomposition unit 330, an anti-aliasing unit 340, an encoder 365, a decoder 367, a buffer 360, and a scan conversion unit 380. The character rendering system 310 is similar to the character rendering system 210 shown in FIG. 1, differing in that the encoder 365 and the decoder 367 are added. The encoder 365, coupled between the anti-aliasing unit 340 and memory 320, generates encoded edge pixel data of a character by encoding and compressing the edge pixel data of the character generated by the anti-aliasing unit 340. The memory 320 stores the encoded edge pixel data 323 of the character together with a plurality of Bezier curve key points 321 used for generating Bezier curves corresponding to character outlines. Since the size of the encoded edge pixel data of the character is much smaller than the size of the original edge pixel data of the character, the size of the memory 320 required for the character rendering system can be reduced. Thus the data transfer of the memory 320 is reduced, and the accessing power consumption concerning the memory 320 is reduced. The decoder 367 is coupled between the memory 320 and the scan conversion unit 380 for recovering the edge pixel data of the character by decoding the encoded edge pixel data of the character received from the memory 320. It is noted that those skilled in the art can utilize different compression methods for the encoder 365 such as Lempel-Ziv (LZ) compression and variable-length coding (VLC), in accordance with design necessity.

The buffer 360, coupled between the encoder 365 and the decoder 367, provides an auxiliary means for transferring the encoded edge pixel data of the character from the encoder 365 to the decoder 367 except via the memory 320. When the buffer 360 is capable of accommodating the encoded edge pixel data of the character, the encoded edge pixel data of the character are transferred from the encoder 365 to the decoder 367 via the buffer 360 so as to accelerate character rendering process and save power consumption by reducing data accessing concerning the memory 320.

Furthermore, the edge pixel data of the character may comprise a plurality of edge pixel data banks corresponding to one bank of the character. The edge pixel data banks are encoded by the encoder 365 for generating a plurality of encoded edge pixel data banks. Similarly, the encoded edge pixel data banks may be sequentially transferred from the encoder 365 to the decoder 367 via the buffer 360 for reducing memory size and bandwidth, and power consumption in accordance with the size of the encoded edge pixel data bank.

The arrangements and functionalities concerning the other elements in the character rendering system 310 are similar to the corresponding elements in the character rendering system 210 shown in FIG. 1, and for the sake of brevity, further description on the character rendering system 310 is omitted.

In summary, the character rendering system 310 is capable of rendering high-quality characters at a higher speed with lower power consumption and lower memory size compared conventional character rendering system based on encoding/decoding mechanism. The character rendering system 310 is also capable of operating a quality-adaptive character rendering process based on an adaptive Bezier curve decomposing process so that high-quality characters are displayed in a high-power mode and low-quality characters are displayed in a low-power mode.

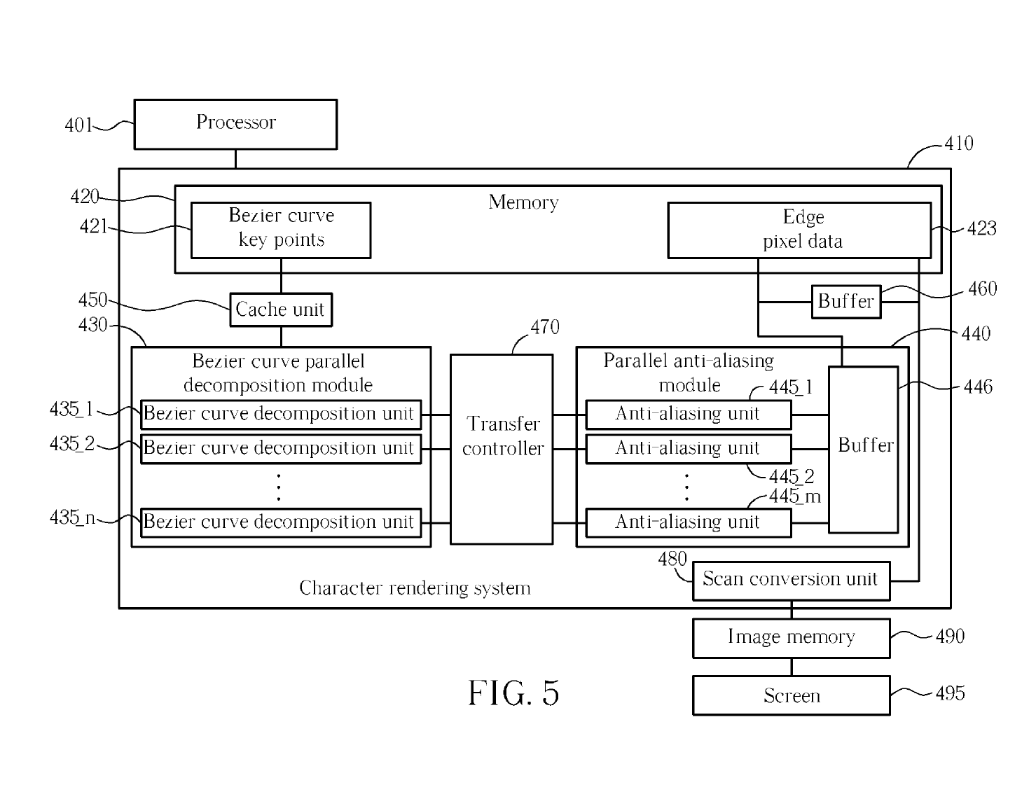

FIG. 5 shows a character rendering system 410 in accordance with a third embodiment of the present invention. The character rendering system 410 comprises a memory 420, a cache unit 450, a Bezier curve parallel decomposition module 430, a transfer controller 470, a parallel anti-aliasing module 440, a buffer 460, and a scan conversion unit 480. The character rendering system 410 is similar to the character rendering system 210 shown in FIG. 1 except the Bezier curve parallel decomposition module 430, transfer controller 470, and parallel anti-aliasing module 440. Other elements not specifically addressed here perform the same functions as those in FIG. 1, and thus are not described in further detail.

The Bezier curve parallel decomposition module 430 functions to generate a plurality of segments corresponding to outline of a character by decomposing a plurality of Bezier curves corresponding to the character based on corresponding Bezier curve key points. The Bezier curve parallel decomposition module 430 comprises a plurality of Bezier curve decomposition units 435_1-435_{—}n. Each of the Bezier curve decomposition units 435_1-435_{—}n decomposes one of the Bezier curves corresponding to the character based on corresponding Bezier curve key points for generating parts of the segments corresponding to the character.

With Bezier curve decomposition units 435_1-435_{—}n, power consumption is reduced because the module working voltage is substantially proportional to an inverse of the number of the parallel Bezier curve decomposition units since the delay caused by the operating transistor is proportional to the applied voltage. For instance, if there are four parallel Bezier curve decomposition units, then the module working voltage can be reduced to a quarter of the module working voltage applied to a single Bezier curve decomposition unit for achieving the same computing throughput. Furthermore, because the module power consumption is proportional to a square of the module working voltage, thus the total module power consumption is proportional to an inverse of the number of the parallel Bezier curve decomposition units.

The Bezier curve parallel decomposition module 430 also dispenses the received Bezier curve key points of the Bezier curves corresponding to the character to the Bezier curve decomposition units 435_1-435_{—}n. For instance, while rendering the character, the Bezier curve decomposition unit 435_1 performs a decomposition process on one of the Bezier curves corresponding to the character based on corresponding Bezier curve key points distributed by the Bezier curve parallel decomposition module 430, and after finishing the decomposition process, the Bezier curve parallel decomposition module 430 will furnish the Bezier curve decomposition unit 435_1 with some other Bezier curve key points so that another one of the Bezier curves corresponding to the character can be decomposed once the Bezier curve decomposition unit 435_1 is idle. Accordingly, the Bezier curves corresponding to the character can be decomposed by means of parallel processing for accelerating decomposing operation.

Besides, the number of segments decomposed from a Bezier curve by each of the Bezier curve decomposition units 435_1-435_{—}n can be adjusted based on the power indication signal. That is, the Bezier curve decomposition units 435_1-435_{—}n performs adaptive decomposition processes on the Bezier curves for generating the segments in a corresponding quality level according to the power indication signal. In one preferred embodiment, the number of segments decomposed from a Bezier curve is adjusted to be smaller for power-saving rendering operation when the power indication signal indicates a low-power mode, and the number of segments decomposed from a Bezier curve is adjusted to be greater for high-quality rendering operation when the power indication signal indicates a high-power mode.

The transfer controller 470 comprises a plurality of input ports and output ports. The input ports of the transfer controller 470 are coupled to the Bezier curve decomposition units 435_1-435_{—}n respectively for receiving data of the segments corresponding to the character. The output ports are coupled to the parallel anti-aliasing module 440. The transfer controller 470 distributes the received data of the segments corresponding to the character to the output ports.

The parallel anti-aliasing module 440 comprises a plurality of anti-aliasing units 445_1-445_{—}m and a buffer 446. The anti-aliasing units 445_1-445_{—}m are coupled to the output ports of the transfer controller 470 respectively. Each of the anti-aliasing units 445_1-445_{—}m receives parts of the data of the segments corresponding to the character from one corresponding output port of the transfer controller 470, and performs an anti-aliasing process thereon for generating parts of the edge pixel data of the character.

For instance, while rendering the character, the anti-aliasing units 445_1 performs an anti-aliasing process on parts of the data of the segments corresponding to the character distributed by the transfer controller 470 for generating parts of the edge pixel data of the character, and after finishing the anti-aliasing process, the transfer controller 470 will furnish the anti-aliasing units 445_1 with some other parts of the data of the segments corresponding to the character so that some other parts of the edge pixel data of the character can be generated once the anti-aliasing units 445_1 is idle. Accordingly, the parallel anti-aliasing module 440 performs the anti-aliasing processes on the data of the segments corresponding to the character by means of parallel processing for accelerating anti-aliasing operation.

Similarly, the total module power consumption is proportional to an inverse of the number of the anti-aliasing units due to the aforementioned module power consumption feature related to the working voltage.

The buffer 446 is coupled to the anti-aliasing units 445_1-445_{—}m for receiving the edge pixel data of the character based on parallel receiving mode and outputting the edge pixel data of the character based on serial transmitting mode. The scan conversion unit 480, coupled to the memory 420 and buffer 460, performs scan conversion processes on the edge pixel data of the character for generating the image data of the character to be displayed on the screen 495.

In summary, the character rendering system 410 is capable of rendering high-quality characters at a higher speed with lower power consumption compared to the conventional character rendering system based on parallel processing mechanism, so as to enable voltage down scaling. Moreover, the character rendering system 410 is capable of operating a quality-adaptive character rendering process based on adaptive parallel Bezier curve decomposing processes so that high-quality characters are displayed in a high-power mode and low-quality characters are displayed in a low-power mode.

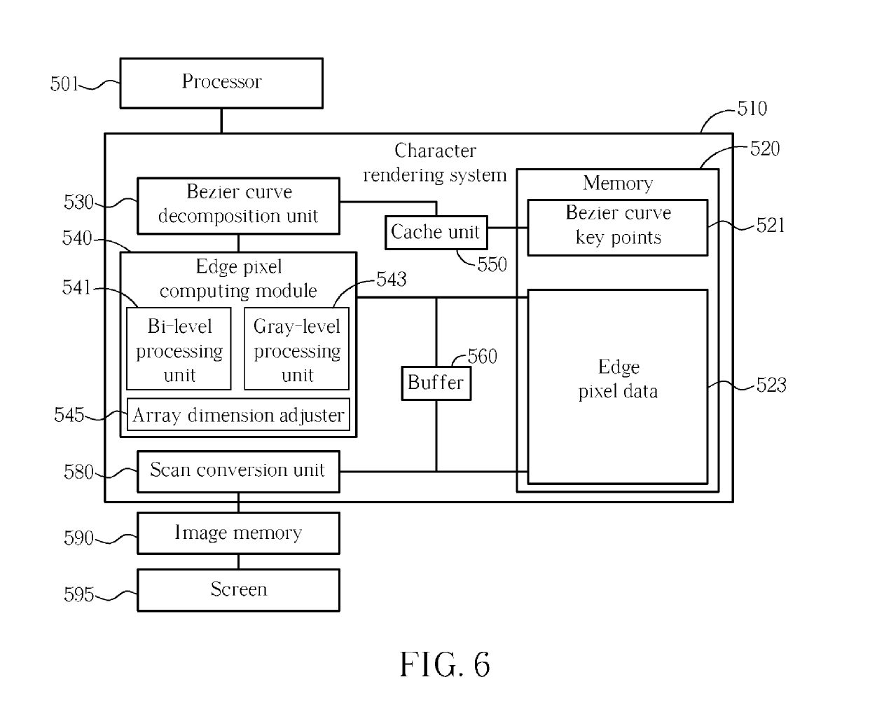

FIG. 6 shows a character rendering system 510 in accordance with a fourth embodiment of the present invention. The character rendering system 510 comprises a memory 520, a cache unit 550, a Bezier curve decomposition unit 530, an edge pixel computing module 540, a buffer 560, and a scan conversion unit 580. The character rendering system 510 is similar to the character rendering system 210 shown in FIG. 1, differing in that the anti-aliasing unit 240 is replaced with the edge pixel computing module 540. The edge pixel computing module 540 comprises a bi-level processing unit 541, a gray-level processing unit 543, and an array dimension adjuster 545. The bi-level processing unit 541 performs a bi-level edge judgment process on the data of the segments corresponding to a character for generating the edge pixel data of the character so as to operate a high-speed and low-quality character rendering process when the power indication signal indicates a low-power mode. The gray-level processing unit 543 performs a gray-level anti-aliasing process on the data of the segments corresponding to a character for generating the edge pixel data of the character so as to operate a high-quality character rendering process when the power indication signal indicates a high-power mode.

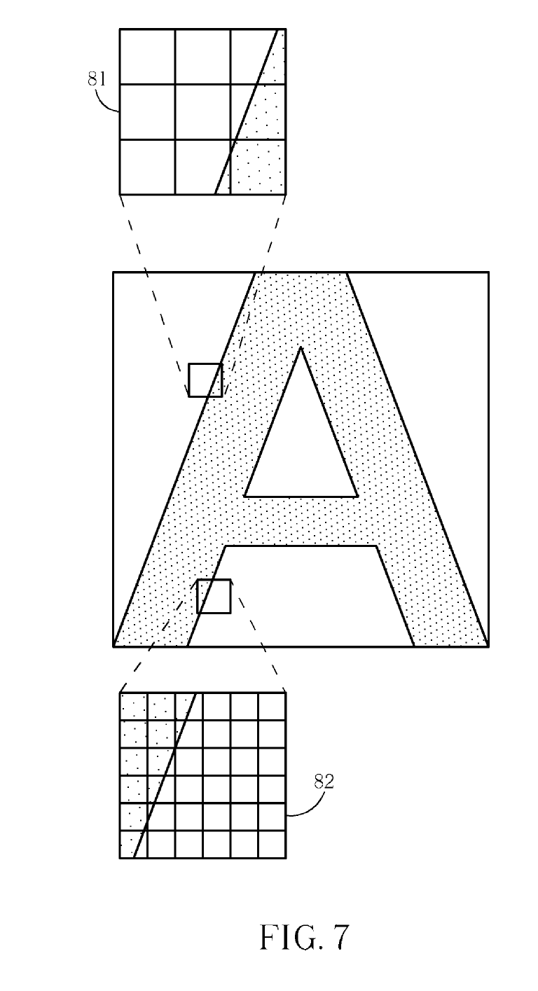

The array dimension adjuster 545 adjusts the pixel division array dimension according to the power indication signal. That is, each edge pixel of the character is divided into a plurality of sub-pixels based on a large pixel division array dimension regulated by the array dimension adjuster 545 for computing corresponding edge pixel data so as to operate a high-quality character rendering process when the power indication signal indicates a high-power mode. Alternatively, each edge pixel of the character is divided into a plurality of sub-pixels based on a small pixel division array dimension regulated by the array dimension adjuster 545 for computing corresponding edge pixel data so as to operate a high-speed and low-quality character rendering process when the power indication signal indicates a low-power mode. For instance, please refer to FIG. 7, which is a schematic diagram showing the operation of the array dimension adjuster 545 on a character “A” having dotted region in low-power and high-power modes according to the present invention. As shown, the array dimension adjuster 545 divides an edge pixel 81 of the character “A” into nine sub-pixels based on a 3×3 pixel division array dimension while operating in a low-power mode, and the array dimension adjuster 545 divides another edge pixel 82 of the character “A” into thirty six sub-pixels based on a 6×6 pixel division array dimension while operating in a high-power mode.

In one embodiment, the gray-level processing unit 543 performs a gray-level anti-aliasing process on the data of the segments corresponding to the character based on the pixel division array dimension for computing corresponding edge pixel data according to the power indication signal. That is, the gray-level processing unit 543 performs a high-precision gray-level anti-aliasing process on the data of the segments corresponding to the character based on the large pixel division array dimension for computing corresponding edge pixel data when the power indication signal indicates a high-power mode, and the gray-level processing unit 543 performs a low-precision gray-level anti-aliasing process on the data of the segments corresponding to the character based on the small pixel division array dimension for computing corresponding edge pixel data when the power indication signal indicates a low-power mode.

In another embodiment, the bi-level processing unit 541 performs a bi-level edge judgment process on the data of the of segments corresponding to the character for computing corresponding edge pixel data when the power indication signal indicates a low-power mode. The gray-level processing unit 543 performs a low-precision gray-level anti-aliasing process on the data of the segments corresponding to the character based on the small pixel division array dimension for computing corresponding edge pixel data when the power indication signal indicates a median-power mode. The gray-level processing unit 543 performs a high-precision gray-level anti-aliasing process on the data of the segments corresponding to the character based on the large pixel division array dimension for computing corresponding edge pixel data when the power indication signal indicates a high-power mode.

The arrangements and functionalities concerning the other elements in the character rendering system 510 are similar to the corresponding elements in the character rendering system 210 shown in FIG. 1, and for the sake of brevity, further description on the character rendering system 510 is omitted.

In summary, the character rendering system 510 is capable of rendering high-quality characters at a higher rendering speed with lower power consumption compared to conventional character rendering system. The character rendering system 510 is also capable of operating a quality-adaptive character rendering process based on an adaptive Bezier curve decomposing process and an adaptive edge pixel computing process so that different qualities of characters are displayed in different power modes.

To sum up, the character rendering system according to the present invention is able to operate a high-quality character rendering process with lower power consumption compared to the prior-art character rendering system. Moreover, the character rendering system of the invention operates a power-aware and quality-adaptive character rendering process with lower memory size so that different qualities of characters are displayed in different power modes.

The present invention is by no means limited to the embodiments as described above by referring to the accompanying drawings, which may be modified and altered in a variety of different ways without departing from the scope of the present invention. Thus, it should be understood by those skilled in the art that various modifications, combinations, sub-combinations and alternations might occur depending on design requirements and other factors insofar as they are within the scope of the appended claims or the equivalents thereof.

What is claimed is:

1. A character rendering system for rendering a character, comprising:
a memory for storing a plurality of Bezier curve key points and edge pixel data of the character;
a cache unit coupled to the memory for storing parts of the Bezier curve key points;
a Bezier curve decomposition unit coupled to the cache unit for generating a plurality of segments corresponding to the character by decomposing a plurality of Bezier curves based on Bezier curve key points corresponding to the character, wherein the Bezier curve decomposition unit fetches the Bezier curve key points corresponding to the character from the cache unit;
an anti-aliasing unit coupled between the Bezier curve decomposition unit and the memory for generating the edge pixel data of the character by performing an anti-aliasing process on the segments corresponding to the character; and
a scan conversion unit coupled to the memory for generating image data of the character by performing a scan conversion process on the edge pixel data of the character.

2. The character rendering system of claim 1, wherein the Bezier curve key points comprise Bezier curve endpoints and Bezier curve control points, and the parts of the Bezier curve key points are corresponding to a plurality of frequently used characters.

3. The character rendering system of claim 1, wherein the Bezier curve decomposition unit performs an adaptive decomposing process on the Bezier curves for generating the segments in a corresponding quality level according to a power indication signal.

4. The character rendering system of claim 1, wherein the memory is a dynamic random access memory (DRAM), and the cache unit comprises a static random access memory (SRAM).

5. The character rendering system of claim 1, further comprising:
a buffer coupled between the anti-aliasing unit and the scan conversion unit for storing the edge pixel data of the character generated by the anti-aliasing unit, wherein the edge pixel data of the character comprise a plurality of edge pixel data banks, and each of the edge pixel data banks is corresponding to one of a plurality of banks of the character and transferred from the anti-aliasing unit to the scan conversion unit via the buffer or the memory.

6. A character rendering system for rendering a character, comprising:
a memory for storing a plurality of Bezier curve key points and edge pixel data of the character;
a Bezier curve decomposition unit coupled to the memory for generating a plurality of segments corresponding to the character by decomposing a plurality of Bezier curves based on Bezier curve key points corresponding to the character;
an anti-aliasing unit coupled to the Bezier curve decomposition unit for generating the edge pixel data of the character by performing an anti-aliasing process on data of the segments corresponding to the character;
an encoder coupled between the anti-aliasing unit and the memory for generating encoded edge pixel data of the character by encoding the edge pixel data of the character;
a decoder coupled to the memory for recovering the edge pixel data of the character by decoding the encoded edge pixel data of the character; and
a scan conversion unit coupled to the decoder for generating image data of the character by performing a scan conversion process on the edge pixel data of the character.

7. The character rendering system of claim 6, wherein the memory is a dynamic random access memory, the Bezier curve key points comprise Bezier curve endpoints and Bezier curve control points, and the Bezier curve decomposition unit performs an adaptive decomposing process on the Bezier curves for generating the segments in a corresponding quality level according to a power indication signal.

8. The character rendering system of claim 6, further comprising: a buffer coupled between the encoder and the decoder for storing the encoded edge pixel data of the character, wherein the edge pixel data of the character comprise a plurality of edge pixel data banks, the encoder encodes the edge pixel data banks for generating a plurality of encoded edge pixel data banks, and each of the encoded edge pixel data banks is corresponding to one of a plurality of banks of the character and transferred from the encoder to the decoder via the buffer or the memory.

9. The character rendering system of claim 6, further comprising:
a buffer coupled between the encoder and the decoder for storing the encoded edge pixel data of the character, wherein the encoded edge pixel data of the character is transferred from the encoder to the decoder via the buffer or the memory.

10. The character rendering system of claim 6, further comprising:
a cache unit coupled between the memory and the Bezier curve decomposition unit for storing parts of the Bezier curve key points, wherein the Bezier curve decomposition unit fetches the Bezier curve key points corresponding to the character from the cache unit or the memory.

11. A character rendering system for rendering a character, comprising:
a memory for storing a plurality of Bezier curve key points and edge pixel data of the character;
a Bezier curve parallel decomposition module coupled to the memory for generating a plurality of segments corresponding to the character by decomposing a plurality of Bezier curves based on Bezier curve key points corresponding to the character, the Bezier curve parallel decomposition module comprising:
a plurality of Bezier curve decomposition units, each of the Bezier curve decomposition units decomposing one of the Bezier curves corresponding to the character based on corresponding Bezier curve key points for generating parts of the segments corresponding to the character, wherein the Bezier curve parallel decomposition module dispenses the received Bezier curve key points of the Bezier curves corresponding to the character to the Bezier curve decomposition units;
a transfer controller comprising a plurality of input ports and a plurality of output ports, the input ports being coupled to the Bezier curve decomposition units respectively for receiving data of the segments corresponding to the character, wherein the transfer controller distributes the received data of the segments corresponding to the character to the output ports;
a parallel anti-aliasing module coupled between the transfer controller and the memory for generating the edge pixel data of the character by performing parallel anti-aliasing processes on the data of the segments corresponding to the character received from the output ports of the transfer controller, the parallel anti-aliasing module comprising:
a plurality of anti-aliasing units coupled to the output ports of the transfer controller respectively, each of the anti-aliasing units performing an anti-aliasing process on parts of the data of the segments corresponding to the character received from a corresponding output port of the transfer controller for generating parts of the edge pixel data of the character; and
a scan conversion unit coupled to the memory for generating image data of the character by performing a scan conversion process on the edge pixel data of the character.

12. The character rendering system of claim 11, wherein the Bezier curve parallel decomposition module performs parallel adaptive decomposing processes on the Bezier curves for generating the segments in a corresponding quality level according to a power indication signal.

13. The character rendering system of claim 11, further comprising:
a buffer coupled between the parallel anti-aliasing module and the scan conversion unit for storing the edge pixel data of the character generated by the parallel anti-aliasing module, wherein the edge pixel data of the character comprise a plurality of edge pixel data banks, and each of the edge pixel data banks is corresponding to one of a plurality of banks of the character and transferred from the parallel anti-aliasing module to the scan conversion unit via the buffer or the memory.

14. The character rendering system of claim 11, wherein the parallel anti-aliasing module further comprises:
a buffer coupled to the anti-aliasing units for receiving the parts of the edge pixel data of the character therefrom and outputting the edge pixel data of the character serially.

15. The character rendering system of claim 11, further comprising:
a cache unit coupled between the memory and the Bezier curve parallel decomposition module for storing parts of the Bezier curve key points, wherein the Bezier curve parallel decomposition module fetches the Bezier curve key points corresponding to the character from the cache unit or the memory.

16. A character rendering system for rendering a character, comprising:
a memory for storing a plurality of Bezier curve key points and edge pixel data of the character;
a Bezier curve decomposition unit coupled to the memory for generating a plurality of segments corresponding to the character by decomposing a plurality of Bezier curves based on Bezier curve key points corresponding to the character;
an edge pixel computing module coupled between the Bezier curve decomposition unit and the memory for generating the edge pixel data of the character from data of the segments corresponding to the character based on a power indication signal, the edge pixel computing module comprising:
a bi-level processing unit for performing a bi-level edge judgment process on the data of the segments corresponding to the character for generating the edge pixel data of the character when the power indication signal indicates a low-power mode; and
a gray-level processing unit for performing a gray-level anti-aliasing process on the data of the segments corresponding to the character for generating the edge pixel data of the character when the power indication signal indicates a high-power mode; and
a scan conversion unit coupled to the memory for generating image data of the character by performing a scan conversion process on the edge pixel data of the character.

17. The character rendering system of claim 16, wherein the Bezier curve decomposition unit performs an adaptive decomposing process on the Bezier curves for generating the segments in a corresponding quality level according to the power indication signal.

18. The character rendering system of claim 16, further comprising:
a buffer coupled between the edge pixel computing module and the scan conversion unit for storing the edge pixel data of the character generated by the edge pixel computing module, wherein the edge pixel data of the character comprise a plurality of edge pixel data banks, and each of the edge pixel data banks is corresponding to one of a plurality of banks of the character and transferred from the edge pixel computing module to the scan conversion unit via the buffer or the memory.

19. The character rendering system of claim 16, further comprising:
a cache unit coupled between the memory and the Bezier curve decomposition unit for storing parts of the Bezier curve key points, wherein the Bezier curve decomposition unit fetches the Bezier curve key points corresponding to the character from the cache unit or the memory.

20. A character rendering system for rendering a character, comprising:
a memory for storing a plurality of Bezier curve key points and edge pixel data of the character;
a Bezier curve decomposition unit coupled to the memory for generating a plurality of segments corresponding to the character by decomposing a plurality of Bezier curves based on Bezier curve key points corresponding to the character;
an edge pixel computing module coupled between the Bezier curve decomposition unit and the memory for generating the edge pixel data of the character from data of the segments corresponding to the character based on a pixel division array dimension, the edge pixel computing module comprising:
an array dimension adjuster for adjusting the pixel division array dimension according to a power indication signal, wherein the edge pixel computing module divides each edge pixel of the character into a plurality of sub-pixels and generates the edge pixel data of the character according to the pixel division array dimension; and
a scan conversion unit coupled to the memory for generating image data of the character by performing a scan conversion process on the edge pixel data of the character.

21. The character rendering system of claim 20, wherein the array dimension adjuster regulates a large pixel division array dimension used for generating the edge pixel data of the character when the power indication signal indicates a high-power mode, and the array dimension adjuster regulates a small pixel division array dimension used for generating the edge pixel data of the character when the power indication signal indicates a low-power mode.

22. The character rendering system of claim 21, wherein the edge pixel computing module further comprises:
a bi-level processing unit for performing a bi-level edge judgment process on the data of the segments corresponding to the character for generating the edge pixel data of the character based on the pixel division array dimension according to the power indication signal, wherein the bi-level processing unit performs a high-precision bi-level anti-aliasing process based on the large pixel division array dimension when the power indication signal indicates the high-power mode, and the bi-level processing unit performs a low-precision bi-level anti-aliasing process based on the small pixel division array dimension when the power indication signal indicates the low-power mode.

23. The character rendering system of claim 21, wherein the edge pixel computing module further comprises:
a gray-level processing unit for performing a gray-level anti-aliasing process on the data of the segments corresponding to the character for generating the edge pixel data of the character based on the pixel division array dimension according to the power indication signal, wherein the gray-level processing unit performs a high-precision gray-level anti-aliasing process based on the large pixel division array dimension when the power indication signal indicates the high-power mode, and the gray-level processing unit performs a low-precision gray-level anti-aliasing process based on the small pixel division array dimension when the power indication signal indicates the low-power mode.

24. The character rendering system of claim 20, wherein the Bezier curve decomposition unit performs an adaptive decomposing process on the Bezier curves for generating the segments in a corresponding quality level according to the power indication signal.

25. The character rendering system of claim 20, further comprising:
a cache unit coupled between the memory and the Bezier curve decomposition unit for storing parts of the Bezier curve key points, wherein the Bezier curve decomposition unit fetches the Bezier curve key points corresponding to the character from the cache unit or the memory; and
a buffer coupled between the edge pixel computing module and the scan conversion unit for storing the edge pixel data of the character.
